(19) United States
(12) Patent Application Publication
(10) Pub. No.: US 2026/0275901 A1
(43) Pub. Date: Sep. 17, 2026

(54) SPARK IGNITION SYSTEMS FOR OPPOSED PISTON ENGINES AND RELATED METHODS

(71) Applicants: Philip Zoldak, Plymouth, MI (US); Andrew Harman, Lapeer, MI (US); Maysam Molana, Troy, MI (US); Philipp Schimmels, Royal Oak, MI (US)

(72) Inventors: Philip Zoldak, Plymouth, MI (US); Andrew Harman, Lapeer, MI (US); Maysam Molana, Troy, MI (US); Philipp Schimmels, Royal Oak, MI (US)

(73) Assignee: Enginuity Power Systems, Inc., Alexandria, VA (US)

(21) Appl. No.: 19/251,790

(22) Filed: Jun. 26, 2025

Related U.S. Application Data
(60) Provisional application No. 63/666,198, filed on Jun. 30, 2024.

(51) Int. Cl. F02B 19/12; F02B 43/10

(52) U.S. Cl. CPC F02B 19/12; F02B 43/10

(57) ABSTRACT

Innovative prechamber are incorporated into a spark ignited opposed piston engine system. Such a system provides performance advantages over long reach spark plug ignition systems.

### RELATED APPLICATIONS

This application claims priority to U.S. Provisional Application 63/666,198 filed Jun. 30, 2024 (the “'198 Application) and is related to Ser. No. 18/493,302 (the “'302 Application”), U.S. patent application Ser. No. 17/696,834 (the “'834 Application), U.S. patent application Ser. No. 17/151,253 (the “'253 Application”), PCT Application No. PCT/US2023/24939 (“'939 Application), U.S. Provisional Application ______ (sometimes referred to as the “ECU application”), U.S. Provision Application ______ (sometimes referred to as the “heated heavy fuel application”) and U.S. Provisional Application No. ______ (sometimes referred to as the “high pressure application”). This application incorporates by reference in their entireties the disclosures of the '198, '302, '834, '253, '939 and ______ applications as if such applications were set forth in full herein.

### GOVERNMENT RIGHTS

The inventive disclosures herein were made with U.S. government support under Contract Number W15P7T-19-D-0157 awarded by the United States Department of Defense. The U.S. government has certain rights in the inventive disclosures.

### TECHNICAL FIELD

This disclosure relates to spark ignition systems and related methods for small engines (e.g., <0.7 L/cylinder), such as four stroke, inwardly opposed piston engines (OP4S), for example.

### INTRODUCTION

This section introduces aspects that may help facilitate a better understanding of the disclosure. Accordingly, the statements of this section are to be read in this light and are not to be understood as admissions about what is, or what is not, prior art.

Currently, there are technical challenges to develop a spark ignition system that includes a combustion prechamber combination that enhances the efficiency of engines, in particular an opposed-piston engine (OPE). Thus, there is a need to develop new spark ignition systems for OPE type engines.

### SUMMARY

The inventors describe various exemplary, inventive spark ignition systems and related methods. As described in more detail herein, embodiments of the disclosure focus on inventive combustion prechambers that are compatible with available spark plugs. The inventive prechambers provide improved combustion stability and burn duration and increase compression ratios which therefore improves engine efficiency.

Further, the inventive ignition systems enable lean burn combustion modes having better fuel economy and brake thermal efficiencies than existing systems.

For example, one disclosed, non-limiting embodiment is directed at a spark ignition system for an engine, the system comprising: a prechamber comprising a volume of 0.2 cc to 5.0 cc; at least one spark plug within the prechamber; a main combustion chamber; and a set of holes or channels connecting the prechamber to the main combustion chamber. In such an exemplary system the prechamber may further comprise one or more direct fuel injectors.

In addition, in one embodiment the prechamber may be composed, for example, of one of a 347 steel, brass, cast iron, stainless steel or a beryllium copper.

In an embodiment, the prechamber may comprise an end wall having a thickness of at least 0.050 inches. However, in another embodiment the prechamber may comprise an end wall having a thickness of 0.125 inches.

In the exemplary system the engine may be configured to use a liquid or gaseous fuel, where the gaseous fuel may be selected from one of a natural gas, methane, propane, ethane, hydrogen, or a blend thereof.

Though we have indicated the volume of the prechamber with at least one spark plug within the prechamber above, it should be understood that the volume of the prechamber may comprise 1.085 cc without the at least one spark plug within the prechamber.

The inventive systems and related methods provide many advantages over existing systems, especially those that use traditional long-reach spark plugs. For example, one exemplary system provides a covIMEP value lower than 3%, while another exemplary system provides a burn duration of fuel at 15 to 40 crank-angle-degrees which is advantageous when compared to an existing system that includes a long reach spark plug.

Still further, another exemplary system provides a heat release of at least 10 J/deg, while another exemplary system provides an engine brake power of 1 kW to 300 kW and yet another exemplary system provides a brake thermal efficiency of 20% to 45%, which again provides advantages when compared to an existing system that includes a long reach spark plug.

In an embodiment, an exemplary system may reduce unwanted NOx and CO, and CO₂ emissions from 5% to 50%. Again, such a reduction provides the inventive systems with advantages when compared to an existing system that includes a long reach spark plug.

In addition to the inventive systems, the inventors also provide related methods. For example, one exemplary method for igniting fuel in an engine may comprise: configuring the engine with a prechamber comprising a volume of 0.2 cc to 5.0 cc; configuring at least one spark plug within the prechamber; and configuring a set of holes or channels connecting the prechamber to a main combustion chamber.

Such an exemplary method may further comprise configuring the prechamber with one or more direct fuel injectors. Further, in such a method the prechamber may be configured with an end wall having a thickness of at least 0.050 to 0.125 inches. Similar to the inventive systems, the inventive method may provide a covIMEP value lower than 3% and/or a heat release of at least 10 J/deg among other advantageous values versus existing systems that use long reach spark plugs.

When a spark plug is not used an inventive method for igniting fuel in an engine may comprise configuring the engine with a prechamber comprising a volume of 1.085 cc; and configuring a set of holes or channels connecting the prechamber to a main combustion chamber.

The inventive systems (and corresponding methods) described above are just some of the inventive systems and methods that will be apparent from the disclosure herein.

### BRIEF DESCRIPTION OF THE DRAWINGS

The present invention is illustrated by way of example and is not limited by the accompanying figures in which like reference numerals indicate similar elements and in which:

FIG. 1A depicts a cross-sectional view of an exemplary spark ignition system configuration through a combustion chamber according to embodiments of the present disclosure.

FIG. 1B depicts a view of an existing long reach spark plug ignition system.

FIG. 1C depicts another view of an exemplary spark ignition system configuration according to an embodiment of the present disclosure.

FIGS. 1D to 1F depict different views and different mechanical drawings of an experimental prechamber according to the disclosure.

FIG. 1G depicts a graph of pressures versus crank angle for a main chamber and inventive prechamber according to the disclosure.

FIGS. 2A to 2C depict different views of an inventive prechamber according to an embodiment of the present disclosure.

FIGS. 2D and 2F depict views of the distribution of stresses for inventive prechambers composed of metal (steel, cast iron, brass or beryllium copper) for two different end wall thicknesses (e.g., 0.050 inches and 0.125 inches) according to embodiments of the present disclosure.

FIGS. 2E and 2F depict views of computed Von Mises stresses for an inventive prechamber composed of beryllium copper for an end wall thickness of 0.125 inches according to an embodiment of the present disclosure.

FIGS. 3A and 3B depict external views of inventive prechambers having different end wall thicknesses that include threads according to embodiments of the present disclosure.

FIGS. 4A and 4B depict graphs that illustrate the difference in performance between an experimental, inventive spark ignition system and an existing long reach spark plug ignition system.

FIGS. 4C to 4J illustrate comparisons of temperature profiles between an existing, known combustion chamber (FIGS. 4C, 4E, 4G and 4I) that includes a long reach spark plug and a combustion chamber of an inventive system (FIGS. 4D, 4F, 4H and 4J) at different fuel consumptions according to embodiments of the present disclosure.

FIGS. 4K to 4N, 4P and 4Q and Tables I to III depict tabular and graphical data illustrating comparisons between an exemplary, experimental and inventive spark ignition system and an existing ignition system according to embodiments of the present disclosure.

Specific embodiments of the present invention are disclosed below with reference to various figures and sketches. Both the description and the illustrations have been drafted with the intent to enhance understanding. For example, the dimensions of some of the elements in the figures may be exaggerated relative to other elements, and well-known elements that are beneficial or even necessary to a commercially successful implementation may not be depicted so that a less obstructed and a clearer presentation of embodiments may be achieved. Simplicity and clarity in both illustration and description are sought to effectively enable a person of skill in the art to make, use, and best practice the present disclosure in view of what is already known in the art. One skilled in the art will appreciate that various modifications and changes may be made to the specific embodiments described herein without departing from the spirit and scope of the present disclosure. Thus, the specification and drawings are to be regarded as illustrative and exemplary rather than restrictive or all-encompassing, and all such modifications to the specific embodiments described below are intended to be included within the scope of the present disclosure.

### DETAILED DESCRIPTION OF EXEMPLARY EMBODIMENTS

The detailed description that follows describes exemplary embodiments and is not intended to be limited to the expressly disclosed combination(s). Therefore, unless otherwise noted, features disclosed herein may be combined to form additional combinations that were not otherwise shown for purposes of brevity.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

As used herein and in the appended claims, the term “comprises,” “comprising,” or variations thereof are intended to refer to a non-exclusive inclusion, such that a process, method, article of manufacture, or apparatus (e.g., an OPE) that comprises a list of elements does not include only those elements in the list, but may include other elements not expressly listed or inherent to such process, method, article of manufacture, or apparatus.

The terms “a” or “an”, as used herein, are defined as one, or more than one. The term “plurality”, as used herein, is defined as two, or more than two. The term “another”, as used herein, is defined as at least a second or more.

Unless otherwise indicated herein, the use of relational terms, if any, such as “first” and “second”, “top” and “bottom”, “back” and “front”, and “left” and “right” and the like are used solely to distinguish one view, entity or action from another view, entity or action without necessarily requiring or implying any actual such relationship, order or importance between such views, entities or actions.

The terms “including” and/or “having”, as used herein, are defined as comprising (i.e., open language).

As used herein the phrases “adapted to”, “operable to” and “configured to” mean “functions to” unless the context or knowledge of one skilled in the art indicates otherwise.

To the extent any dimension, weight, size, percentages, or operating parameters are described herein or shown in the figures (collectively “parameters”), it should be understood that such parameters are non-limiting and merely exemplary to allow those skilled in the art to understand the inventive embodiments described herein.

Similar reference numbers may denote similar components and/or features throughout the attached drawings.

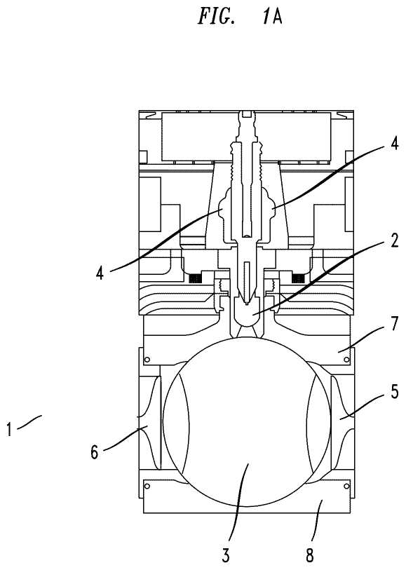

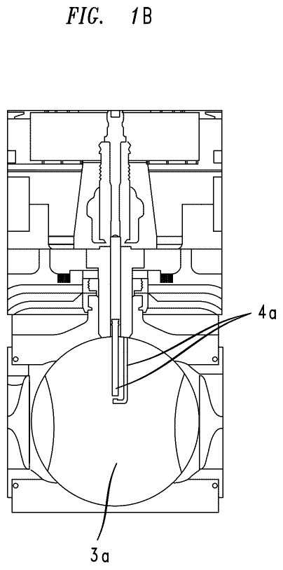

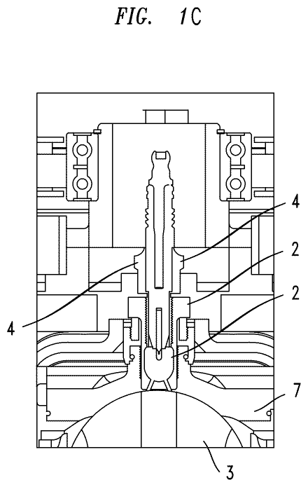

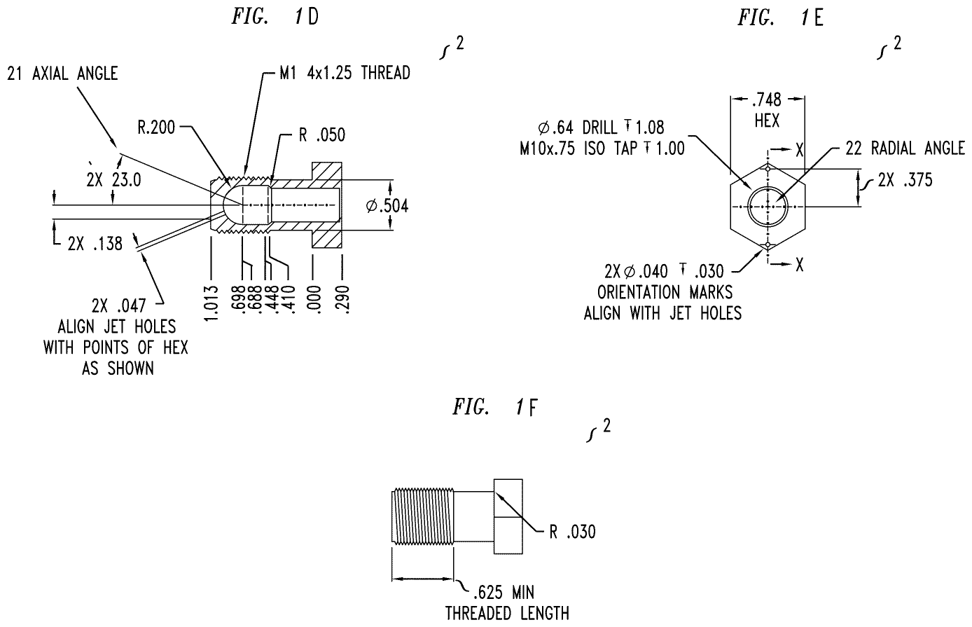

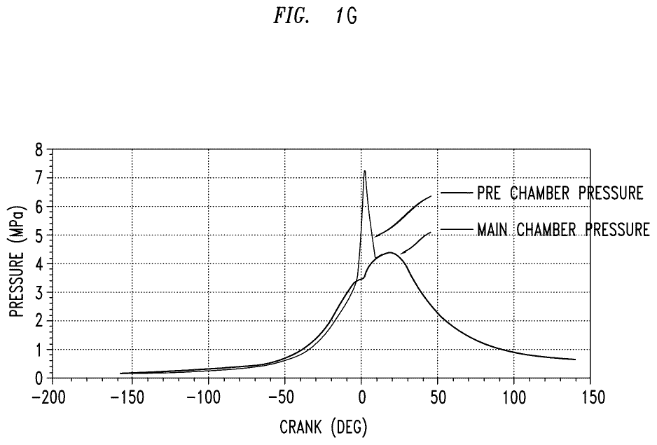

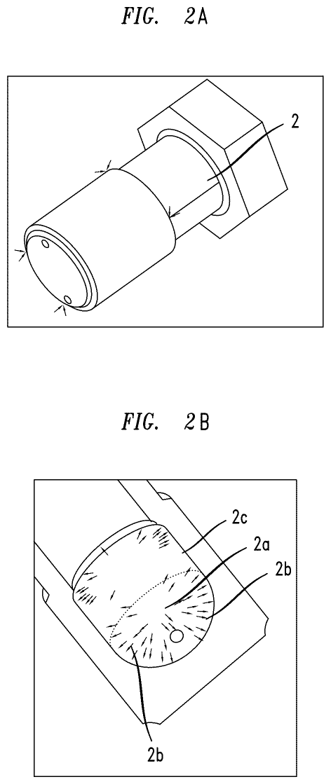

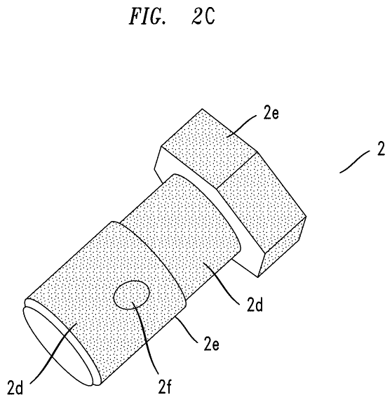

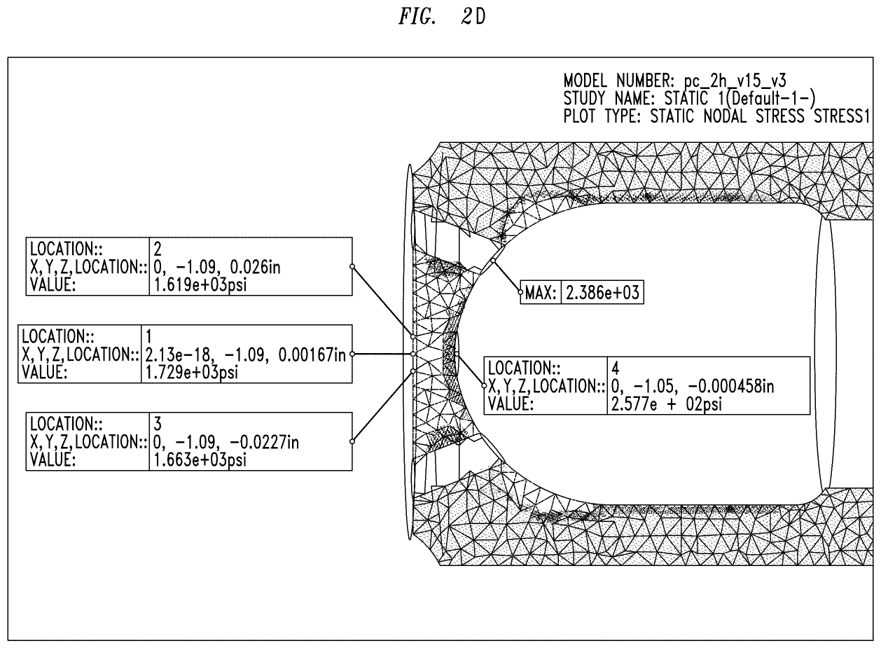

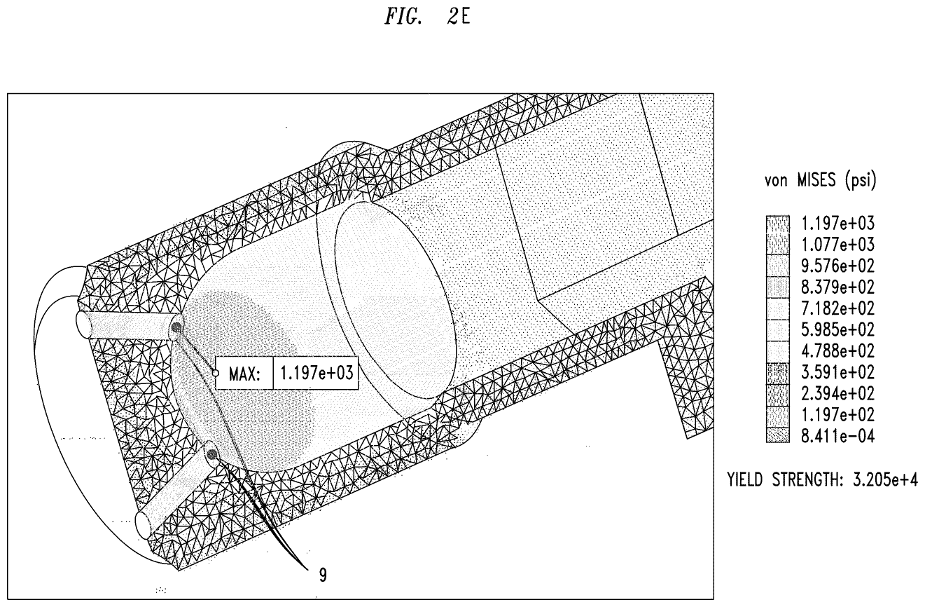

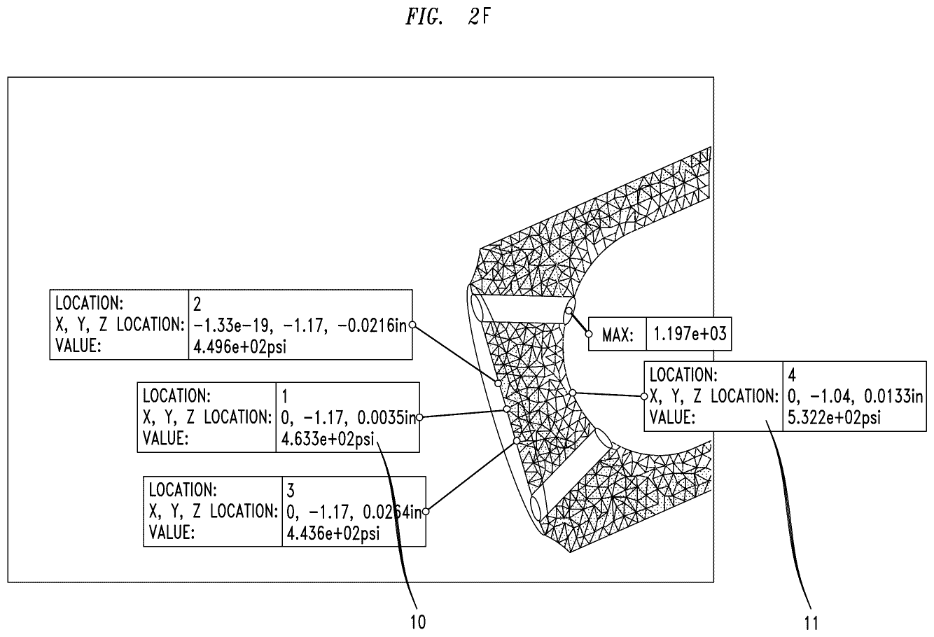

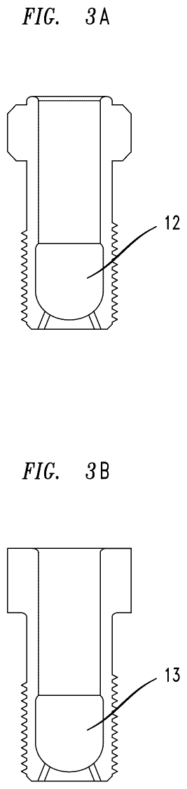

Referring to FIG. 1A there is depicted a cross-sectional view of an exemplary spark ignition system 1 configuration through its combustion chamber according to an embodiment of the present disclosure. The system 1 may be included in an OPE engine that may be configured to operate using both gaseous and/or liquid fuel. Further, the OPE may operate using one or more combustion modes, such as lean, stoichiometric, and rich modes. Such an OPE may have predetermined lengths and predetermined diameters. In one embodiment, the stroke length of each of the opposed pistons may be twice the amount of a conventional engine, for example, it being understood that the piston stroke lengths may be geometrically determined in accordance with the piston stroke length and the lengths of apertures formed in a wall of the cylinders through which flow exhaust gases and air for combustion (e.g., see element 5a in FIG. 3C of the '253 Application). Thus, the total difference between the spacing of the pistons at closest approach to each other (i.e., at “top dead center”) and the maximum spacing of the pistons during the engine cycle (i.e., at “bottom dead center”) may also be twice the amount of a conventional engine, for example. As shown in FIG. 1A (a cross-section of engine through the combustion chamber), the system 1 may comprise an inventive, experimental prechamber 2, configured with (or without) a spark plug 4 (e.g., M10 type), intake and exhaust valves 5,6 and inwardly opposed pistons 3. Additionally, the system may be configured with flow channels 9 (see FIG. 2E) to connect the prechamber 2 with the main combustion chamber 3 and are an important to optimize the embodiments described herein. The flow channels or holes 9 may vary in number from at least 1 to 10. A flow channel or hole may be configured or shaped as cylindrical, conical diverging, conical converging, or oval to name some of the non-limiting shapes of the channels or holes 9. In addition, the angle of a channel or hole may vary from 0 deg to 90 degrees from the center line in an axial direction (see Axial angle 21 in FIGS. 1D) and 0 deg to 360 degrees in a radial direction (see radial angle 22 in FIG. 1E). In an embodiment, the radial angle 22 defines the placement of the outlets of the channels 9. In an embodiment, these geometric parameters may be selected experimentally or via simulations to optimize the performance of the system 1.

FIG. 1B depicts a view of the position of an existing long reach spark plug 4a as it extends into its corresponding main combustion chamber (hidden by piston 3a). In comparison, the spark plug 4 of the inventive system 1 shown in FIG. 1A does not extend into its main combustion chamber (hidden by piston 3). Rather, the spark plug 4 extends into the inventive experimental prechamber 2. For explanatory purposes only, when we refer to FIGS. 1A and 1B we may refer to a combustion chamber or piston 3,3a since the former is hidden from view by the latter.

FIG. 1C depicts yet another view of the inventive system 1 and the experimental prechamber 2 while FIGS. 1D to 1F depict different views and different mechanical drawings of the experimental prechamber 2, it being understood that the dimensions and other parameters shown in FIGS. 1D to 1F are for merely exemplary, and, therefore, non-limiting.

The inventors discovered that the incorporation of the inventive prechamber 2 in the inventive system 1 caused a peak pressure in the prechamber 2 to occur before a peak pressure in the cylinder. FIG. 1G depicts graphs of the pressures in the main combustion chamber 3 and prechamber 2 in relation to the crank angle of the engine. As illustrated by FIG. 1G, the maximum differential of pressure between the prechamber 2 and an engine's cylinder was measured at 4.4 Mpa (640 psi). Still further, the inventors discovered that such a difference in pressure led to stresses in the surfaces of the prechamber 2.

FIGS. 2A to 2C depict different views of the inventive, experimental prechamber 2.

FIG. 2A depicts a view of the inventive, experimental prechamber 2 without threads, FIG. 2B depicts a partial, cut away, interior view 2a of pressures 2b (e.g., 640 psi) applied to the internal surfaces of the end wall 2c of the prechamber 2 while FIG. 2C depicts the structural finite element analysis (FEA) mesh 2d applied to a solid body 2e of the experimental prechamber in 3D 2. The mesh 2d may comprise a plurality of raised elements (e.g., 198,000 elements, only a few of the raised elements 2f are circled in FIG. 2C), each of which may measure 0.020 inches in diameter, for example, and is used during FEA to determine the mechanical stress and validate the structural strength of the prechamber 2 to withstand the combustion pressure which the prechamber 2 will experience. In an embodiment, the experimental prechamber 2 may be composed of a 347 stainless steel, cast-iron, brass. Alternatively, the experimental prechamber 2 may be composed of a beryllium copper.

As noted previously, the inventors discovered that mechanical stresses within the end wall of the prechamber 2 were due to the differences in pressure between the prechamber and combustion chamber (not shown). For example, the maximum stress in an experimental prechamber 2 composed of beryllium copper was simulated at 2387 psi (with an end wall thickness of 0.050 inches), though this is lower than the material maximum tensile strength of 130,000 psi. Accordingly, the use of a beryllium copper based prechamber provides stresses far below a maximum stress, making such a composition safe for use and operation.

In an embodiment, using beryllium copper prechamber 2 the inventors increased the thickness of the end wall 2c from 0.050 inches to 0.125 inches which had the effect of lowering the simulated maximum stress from 2387 psi to 1197 psi (see FIGS. 2D and 2F). Further, by increasing the thickness of the end wall 2c the distribution of stresses on the end wall 2c were made more uniform (i.e., the location of maximum stress was moved from the outside surface of the end wall 2c to the inside surface of the end wall 2c). For example, for a prechamber with an end wall thickness of 0.050 inches the difference between the outside and inside stress was +1471 psi while in the prechamber with an increased thickness of 0.25 inches the highest stress was on the inside surface, and the difference between the outside and inside stress was −69 psi.

The inventors again note that beryllium copper is but one non-limiting, composition of the inventive prechamber. Other materials may be used, such as a stainless steel, brass, steel, and/or cast iron, for example.

FIGS. 2D and 2F depict views of the distribution of stresses for a beryllium copper prechamber 2 having an end wall thickness of 0.050 inches (FIG. 2D) versus 0.125 inches (FIG. 2F) while FIG. 2E depicts views of simulated Von Mises stresses for the thickened end wall at 0.125 inches.

FIG. 2E illustrates the computed Von Mises stresses of the internal surface of a beryllium copper prechamber 2. The highest stresses occurred at the edges 9 of the jet holes inside the prechamber's 2 combustion cavity.

For the readers reference FIGS. 3A and 3B depict external views of inventive prechambers 2 that now include threads 12, 13 where the prechamber 2 in FIG. 3A may have an end wall thickness of 0.050 inches and the prechamber 2 in FIG. 3B may have an end wall thickness of 0.125 inches, for example.

As noted previously, the inventive spark ignition system 1 need not include a long reach spark plug. Instead, the inventive, experimental prechamber 2 is included. In an embodiment, the inventive, experimental prechamber 2 may ignite a fuel as follows.

During an exemplary compression stroke of the engine a lean mixture of fuel may be forced into the inventive prechamber 2 by the movement of the pistons 3 where the fuel may mix with gas residuals from previous combustion cycles. In an embodiment, the force upon the fuel (e.g., a liquid (JP8, gasoline) or a gas (hydrogen,, methane, natural gas, propane)) and air mixture combined with the relatively small volume of the prechamber 2 (compared to the main combustion chamber 3) creates turbulence of the fuel-air mixture within the prechamber 2 (e.g., the volume of the inventive prechamber 2 may be, but is not limited to, 0.843 cc with a spark plug inside, or 1.085 cc without a spark plug which corresponds respectively to 2.17% and 2.81% of the combustion chamber volume at top dead center (TDC)) to name one non-limiting example. Once forced into the prechamber 2 via the channels or holes 9 the fuel may be initially ignited by the spark plug 4 as the pistons 3 reach TDC. The ignition may form a flame kernel. Thereafter, the flame kernel may expand volumetrically to form a flame (or flames) due to the turbulence within the prechamber 2. Substantially simultaneously both the temperature and pressure within the prechamber 2 may increase. Thereafter, during a combustion stroke the turbulent, enhanced flame (or flames) may be forced out of the prechamber 2 due to the increasing pressure and temperature via the channels (or holes) 9 and into the main combustion chamber 3 at a high rate of speed. Thereafter, a fuel and air mixture in the main combustion chamber 3 may be ignited by the enhanced, turbulent flame or flames instead of by a single spark ignition point.

The inventors compared the operation of the inventive spark ignition system 1 with its inventive prechamber 2 to an existing spark ignition system that used a long reach spark plug (e.g., M14 Autolite long reach spark plug.).

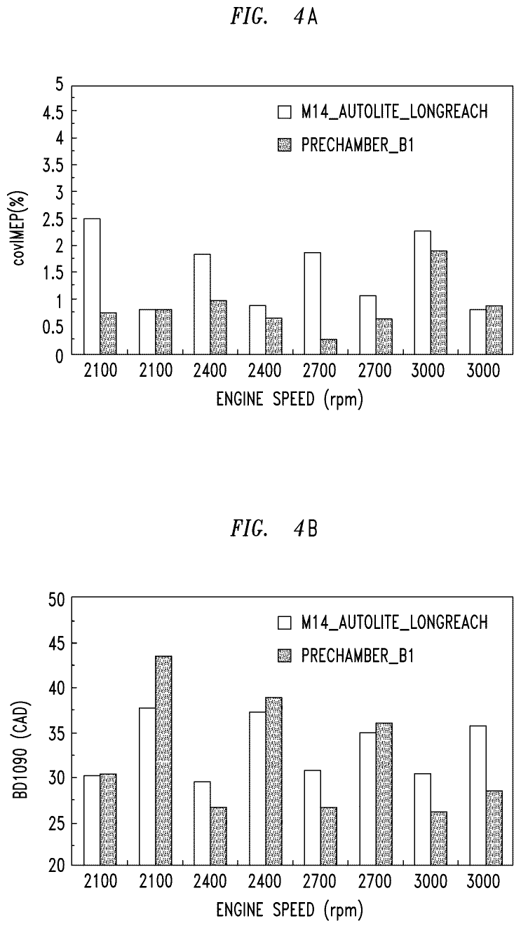

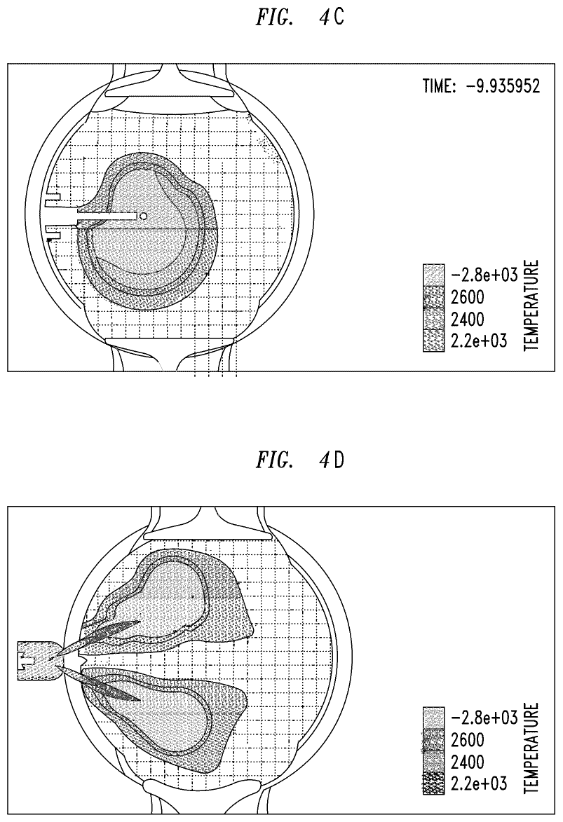

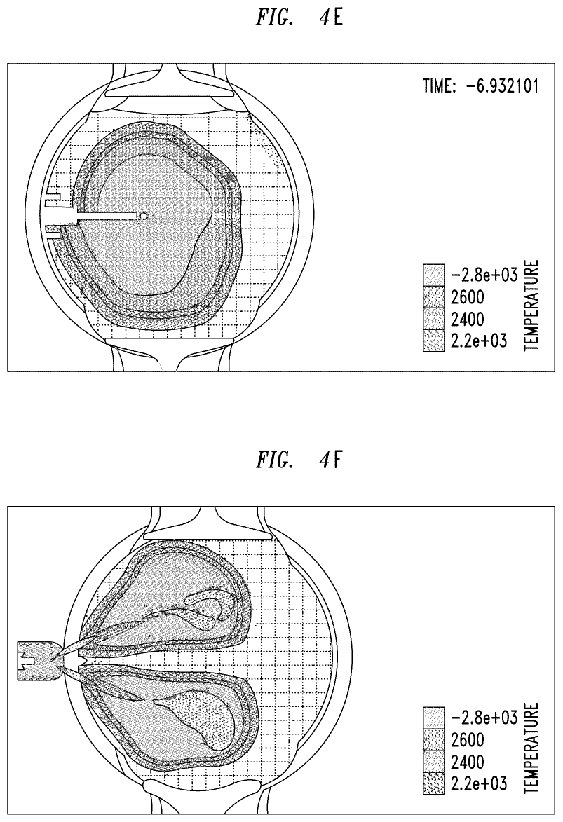

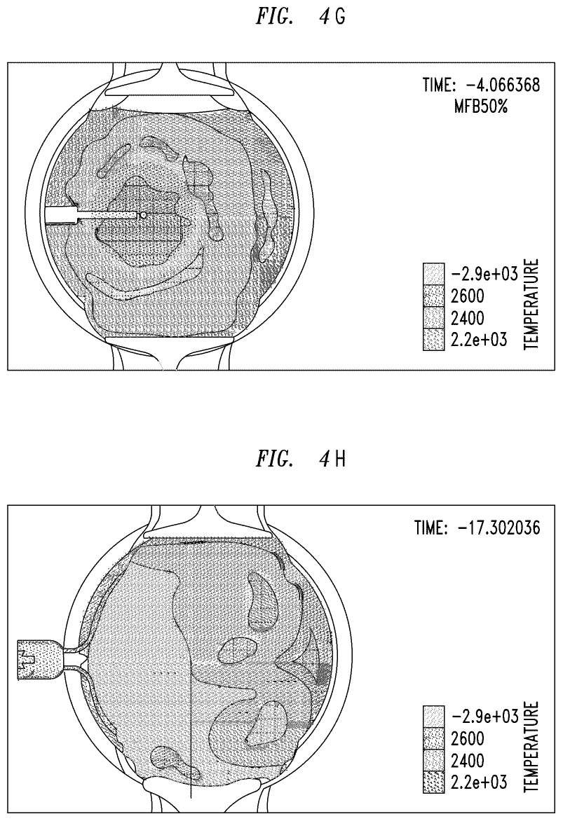

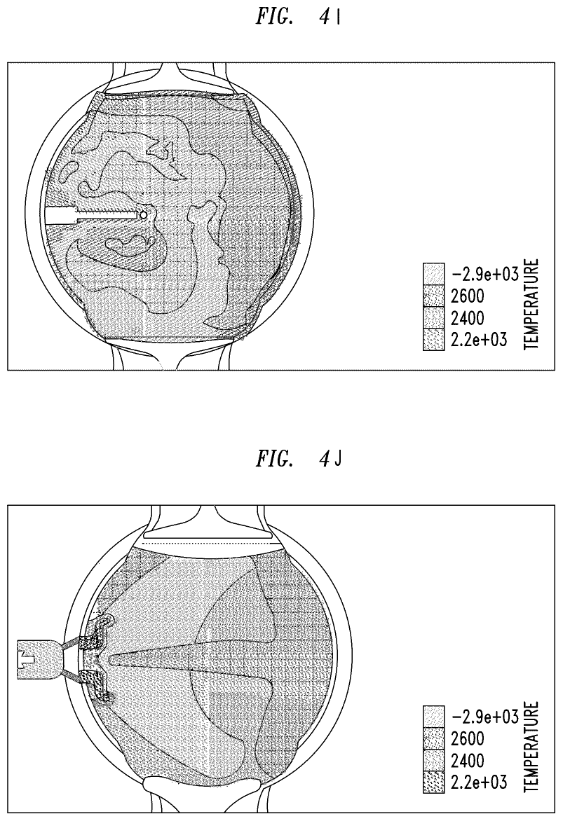

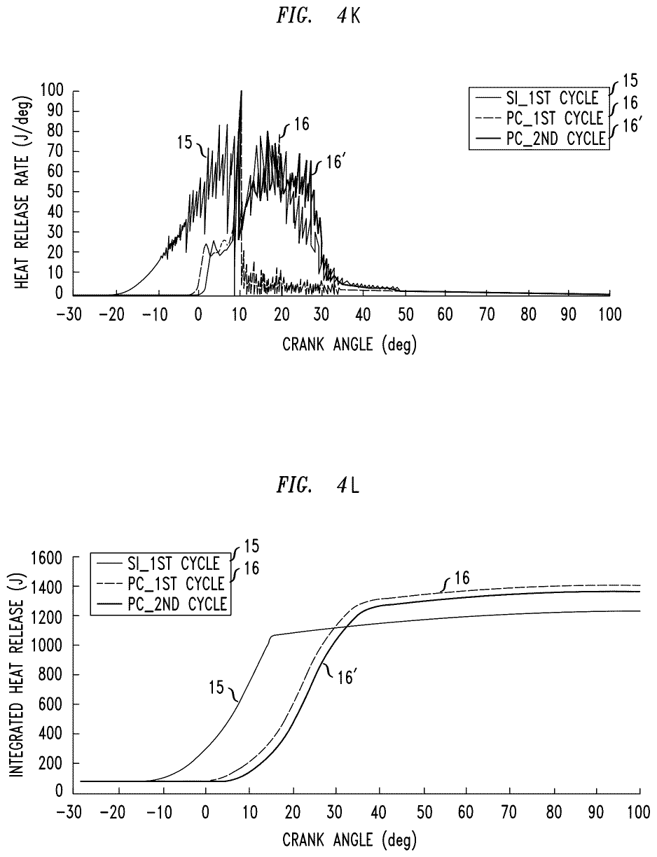

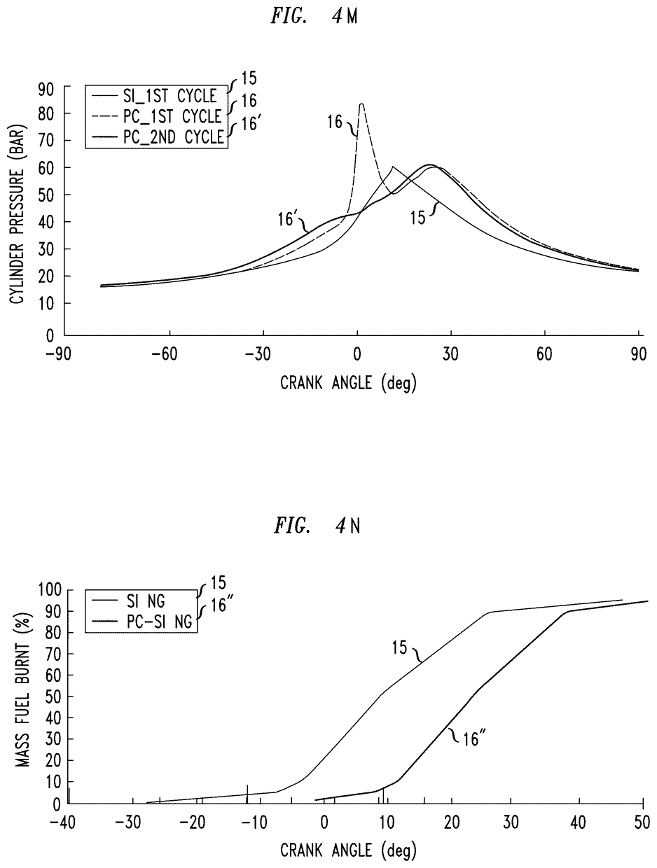

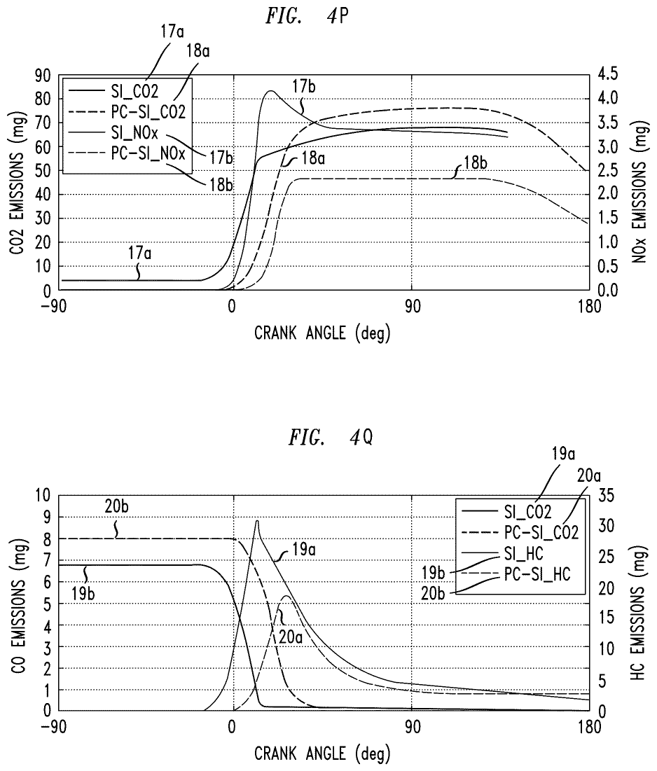

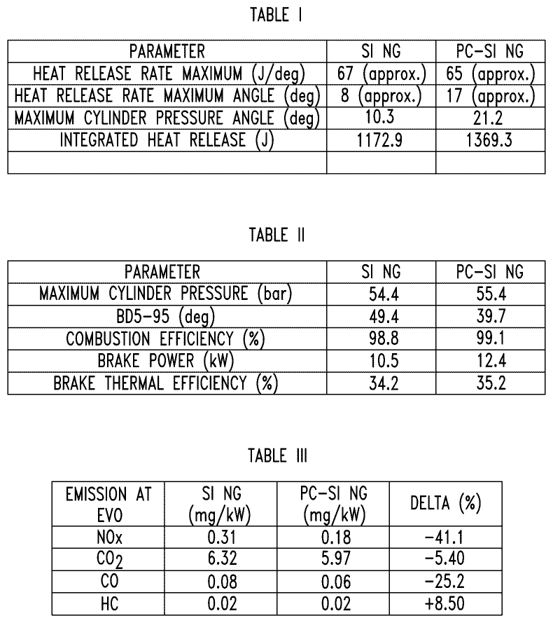

Referring now to FIGS. 4A and 4B there are depicted graphs that illustrate the difference in performance between the inventive spark ignition system 1 and prechamber 2 and an existing long reach spark plug ignition system. In more detail, FIG. 4A illustrates that the inventive spark ignition system 1 provides improved combustion stability when compared to a long reach spark plug ignition system (coefficient variation of indicated mean effective pressure (covIMEP) is less than 1%).

In more detail, FIG. 4A depicts a comparison of the inventive prechamber 2 versus an existing Autolite spark plug in terms of combustion stability versus engine speed. In FIG. 4A covIMEP is indicated as a mean effective pressure (IMEP) of combustion. For the reader's benefit, a covIMEP value of less than 3% is usually assumed as a stable combustion. Accordingly, FIG. 4A indicates that the inventive prechamber 2 provides covIMEP values much lower than 3%, therefore indicating the prechamber 2 and inventive system 1 provide increased combustion stability versus existing systems.

Referring now to FIG. 4B there is depicted a graph illustrating that fuel is burned faster in the inventive system 1 compared to an existing ignition system that includes a long reach spark plug. Accordingly, the inventors discovered that the inventive system 1 provides increased combustion efficiencies and power output versus an existing system.

In more detail, to evaluate the experimental, inventive system 1 versus an existing system the inventors compared the burn duration (BD), (defined as the fuel mass burned during combustion from 10% to 90% of the heat released (i.e., BD1090)) for two engines, one operating using the inventive prechamber 2 and another operating using an existing ignition system (e.g., one using an Autolite long reach spark plug). From FIG. 4B the inventors discovered that the burn duration of fuel using the inventive prechamber 2 is shorter than that of the existing system that includes a long reach spark plug at the majority of engine speeds. Accordingly, the inventors concluded that the experimental, inventive system 1 and its prechamber 2 burns fuel faster which is beneficial for the shape of a heat release profile and combustion efficiency.

For the reader's further reference FIGS. 4C to 4J illustrate a comparison of the burn rate of fuel between an existing spark ignition system (FIGS. 4C, 4E, 4G and 4I) versus the experimental, inventive spark ignition system 1 (FIGS. 4D, 4F, 4H and 4J).

In more detail, FIG. 4C illustrates a temperature profile of an existing, known combustion chamber that includes a long reach spark plug (referred to herein as “existing, known combustion chamber” or simply as “existing system”) when 5% of the fuel is burnt (MFB 5%) while FIG. 4D illustrates a temperature profile of the combustion chamber of the inventive system 1 when 5% of the fuel is burnt (MFB5%). Similarly, FIG. 4E illustrates a temperature profile of an existing, known combustion chamber when 10% of the fuel is burnt (MFB 10%), FIG. 4F illustrates a temperature profile of the combustion chamber of the inventive system 1 when 10% of the fuel is burnt (MFB10%), FIG. 4G illustrates a temperature profile of an existing, known combustion chamber when 50% of the fuel is burnt (MFB 50%), FIG. 4H illustrates a temperature profile of the combustion chamber of the inventive system 1 when 50% of the fuel is burnt (MFB 50%), FIG. 4I illustrates a temperature profile of an existing, known combustion chamber when 90% of the fuel is burnt (MFB 90%) while FIG. 4J illustrates a temperature profile of the combustion chamber of the inventive system 1 when 90% of the fuel is burnt (MFB 90%).

Based on the experimental, simulated data depicted in FIGS. 4C to 4J the inventors discovered that the inventive system 1 was able to burn (use) fuel faster than an existing system that used a long reach spark plug which is desirable for the efficiency and power generation purposes.

Referring now to FIGS. 4K to 4N, 4P and 4Q and Tables I to III there are provided tabular and graphical data that illustrate comparisons between the inventive spark ignition system 1 and an existing ignition system (e.g., Autolite long reach spark plug ignition system).

In more detail, FIG. 4K depicts graphs of the heat release rate versus crank angle degree for an existing system 15 and the inventive system 16,16′ (for two cycles: a first cycle 16 and a second cycle 16′). From FIG. 4K it can be seen that a significant amount of heat release occurs in the experimental prechamber 2 of the inventive system 1 as compared to the existing system which is beneficial for performance. Similarly, FIG. 4L depicts integrated heat release rates of the existing system 15 and inventive system (again, over two cycles 16, 16′). From FIGS. 4K and 4L the inventors discovered the inventive system 1 that includes the inventive prechamber 2 provides a higher amount of heat release (e.g., a heat release of at least 10 J/deg). Table I sets forth data that summarizes the graphs in FIGS. 4K and 4L.

Referring now to FIGS. 4M and 4N there are depicted graphs of cylinder pressure versus crank angle degree (FIG. 4M) and amount of mass burnt versus crank angle degree (FIG. 4N) for an existing system 15 and the inventive system 16, 16′ and 16″. Table II provides data that summarizes the graphs in FIGS. 4M and 4N. From FIGS. 4M and 4N and Table II the inventors discovered the following: (i) the experimental, inventive system 1 generates higher maximum pressures compared to an existing system (e.g., the inventive prechamber 2 produces 55.4 bar versus 54.4 for an existing system); (ii) the experimental, inventive system 1 provides shorter burn duration between 5% and 95% of the fuel mass (BD5-95) compared to an existing system (at 15 to 40 crank-angle-degrees); (iii) the experimental, inventive system 1 provides a higher combustion efficiency versus an existing system; (iv) the experimental, inventive system 1 provides a higher brake power versus an existing system (e.g., an existing system produced 10.5 kW of brake power while the experimental, inventive system 1 and prechamber 2 produced 1 kW to 300 kW (e.g., 12.4 kW an increase of 18.1%) of brake power; and (v) the experimental, inventive system 1 provides 2% to 45% higher brake thermal efficiency compared to that of an existing, conventional system (e.g., 2.91% higher than a long reach spark plug ignition system).

Referring now to FIGS. 4P and 4Q there are depicted graphs of CO2 (FIG. 4P) and CO (FIG. 4Q) emissions for an existing system 17a,17b and the inventive system 18a,18b. Table III provides data that supplements and/or summarizes the graphs in FIGS. 4P and 4Q.

In particular, the reader is directed to Table III which sets forth data that was measured at the time of an exhaust valve opening (EVO). From this data the inventors discovered that the inventive system 1 that includes the inventive prechamber 2 reduced unwanted NOx and CO, and CO₂ emissions significantly (e.g., unwanted NOx and CO, and CO₂ emissions are reduced from 5% to 50% compared to an existing system that uses a long-reach spark plug.

The inventors believe that the inventive, experimental prechamber 2 and spark ignition system 1 provide a number of advantages over existing spark ignition systems. For example, the inventors believe the inventive system 1 provides higher performance and efficiencies, less fuel consumption, and higher compression ratios than existing spark ignition systems. Further, the inventive system 1 reduces the chances of unwanted pre-ignition, auto-ignition and knock occurrences. Furthermore, because the inventive system 1 does not require the use of a long reach spark plug (i.e., an existing, non-long reach spark plug can be used as spark plug 4) the system may be less expensive to manufacture.

The claim language that follows below is incorporated herein by reference in expanded form, that is, hierarchically from broadest to narrowest, with each possible combination indicated by the multiple dependent claim references described as a unique standalone embodiment.

While benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

We claim:

1. A spark ignition system for an engine comprising:
a prechamber comprising a volume of 0.2 cc to 5.0 cc;
at least one spark plug within the prechamber;
a main combustion chamber; and
holes or channels connecting the prechamber to the main combustion chamber.

2. The system as in claim 1 wherein the prechamber further comprises one or more direct fuel injectors.

3. The system as in claim 1 wherein the prechamber is composed of one of a 347 steel, brass, cast iron, stainless steel, or a beryllium copper.

4. The system as in claim 1 wherein the prechamber comprises an end wall having a thickness of at least 0.050 inches.

5. The system as in claim 1 wherein the prechamber comprises an end wall having a thickness of 0.125 inches.

6. The system as in claim 1 wherein the engine is configured to use a liquid or gaseous fuel.

7. The system as in claim 6 wherein the gaseous fuel is selected from one of a natural gas, methane, propane, ethane, hydrogen, or a blend thereof.

8. The system as in claim 1 wherein the volume of the prechamber comprises 1.085 cc without the at least one spark plug within the prechamber.

9. The system as in claim 1 wherein the system provides a covIMEP value lower than 3%.

10. The system as in claim 1 wherein the system provides a burn duration of fuel at 15 to 40 crank-angle-degrees.

11. The system as in claim 1 wherein the system provides a heat release of at least 10 J/deg.

12. The system as in claim 1 wherein the system provides an engine brake power of 1 kW to 300 kW.

13. The system as in claim 1 wherein the system provides a brake thermal efficiency of 2% to 45%.

14. The system as in claim 1 wherein the system reduces unwanted NOx and CO, and CO₂ emissions from 5% to 50%.

15. A method for igniting fuel in an engine, the method comprising:
configuring the engine with a prechamber comprising a volume of 0.2 cc to 5.0 cc;
configuring at least one spark plug within the prechamber; and
configuring holes or channels connecting the prechamber to a main combustion chamber.

16. The method as in claim 15 wherein the method further comprises configuring the prechamber with one or more direct fuel injectors.

17. The method as in claim 15 further comprising configuring the prechamber with an end wall having a thickness of at least 0.050 to 0.125 inches.

18. The method as in claim 15, wherein the method provides a covIMEP value lower than 3%.

19. The method as in claim 15 wherein the method provides a heat release of at least 10 J/deg.

20. A method for igniting fuel in an engine, the method comprising:
configuring the engine with a prechamber comprising a volume of 1.085 cc; and
configuring a set of holes or channels connecting the prechamber to a main combustion chamber.
